(19) United States
(12) Patent Application Publication
(10) Pub. No.: US 2021/0012321 A1
(43) Pub. Date: Jan. 14, 2021

(54) ENHANCED PAYMENT PROCESSING

(71) Applicant: MASTERCARD INTERNATIONAL INCORPORATED, Purchase, NY (US)

(72) Inventor: Julie MCGOVERN, London (GB)

(21) Appl. No.: 16/505,053

(22) Filed: Jul. 8, 2019

(51) Int. Cl. G06Q 20/34; G06Q 20/22; G06Q 20/40; G06Q 20/10

(52) U.S. Cl. CPC G06Q 20/351; G06Q 20/105; G06Q 20/409; G06Q 20/223

(57) ABSTRACT

Enhanced payment processing enables a card payment on the buyer side to end up as a bank transfer to the supplier. An enhanced payment processing service can receive a request from a first party to make a payment to a second party. The request can include one or more transactions, each transaction comprising at least a second party identifier and an amount of the payment. In response to receiving the request, the service can obtain VCN information for each transaction; and, for each transaction, communicate the VCN information and a request for an enhanced payment processing transfer to an enhanced payment processing bank. The request for the enhanced payment processing transfer comprises the second party identifier and amount of the payment; and is a request for an electronic payment transfer from the enhanced payment processing bank to a financial institution associated with the second party identifier according to a processing result of the VCN information.

### BACKGROUND

Payment cards such as credit cards and debit cards are widely used for most forms of financial transactions. Currently, very few suppliers in the business to business space accept card payments. The process of accepting and processing payment cards is cumbersome for the supplier. Purchase orders, invoices, and bank transfers dominate as the default payment method and require zero process effort from the supplier. However, many businesses, including buyers, would like to use commercial card products in order to enhance their working capital.

### BRIEF SUMMARY

Enhanced payment processing is provided. The described enhanced payment processing enables a card payment on the buyer side to end up as a bank transfer to the supplier. The described enhanced payment processing can enable business to business payments to be made on a buyer's payment card while facilitating direct to bank account payments to suppliers.

An enhanced payment processing service can receive a request from a first party to make a payment to a second party. The request can include one or more transactions, with each transaction comprising at least a second party identifier and an amount of the payment. In response to receiving the request, the enhanced payment processing service can obtain virtual card number information for each transaction. For each transaction, the enhanced payment processing service can communicate the virtual card number information and a request for an enhanced payment processing transfer to an enhanced payment processing bank. The request for the enhanced payment processing transfer is a request for an electronic payment transfer from the enhanced payment processing bank to a financial institution associated with the second party identifier according to a processing result of the virtual card number information. The request for the enhanced payment processing transfer comprises the second party identifier and the amount of the payment.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example conventional electronic payment process.

FIG. 2 illustrates an example conventional payment card process.

FIGS. 3A and 3B illustrate example enhanced payment processing according to example embodiments of the invention.

FIG. 4 shows an example process flow diagram for providing enhanced payment processing according to an embodiment of the invention.

FIG. 5 illustrates components of a computing system that may be used in certain embodiments described herein.

### DETAILED DESCRIPTION

Enhanced payment processing is provided. The described enhanced payment processing enables a card payment on the buyer side to end up as a bank transfer to the supplier. The described enhanced payment processing can enable business to business payments to be made on a buyer's payment card while facilitating direct to bank account payments to suppliers.

The described enhanced payment processing solves the barrier to businesses using commercial payment card products to pay their suppliers. The described enhanced payment processing allows a buyer to pay any supplier having a bank account using a payment card. Advantageously, there is no requirement that the supplier accept payment cards in order for a buyer to pay using a payment card. The enhanced payment processing effectively removes the need for card acceptance by the supplier.

Through the enhanced payment processing, buyers having an enhanced payment processing account with an enhanced payment processing bank can enhance working capital by allowing card payments to be made to the enhanced payment processing bank rather than to the supplier. The enhanced payment processing bank then pays the supplier on the buyer's behalf. Advantageously, rather than the funds leaving the buyer's account the same day or soon after, the buyer receives a full statement cycle (plus the payment terms with the supplier) to pay the supplier.

An “enhanced payment processing account” refers to an account allowing a buyer to make a direct bank account payment to a supplier through a payment card.

An “enhanced payment processing bank” refers to a financial institution through which the buyer has an enhanced payment processing account. The enhanced payment processing bank utilizes a merchant system and a payment transfer system in order to allow the buyer to make the direct bank account payment to the supplier through the payment card.

“Business to business” (B2B) refers to a type of commerce transaction that is based on the exchange of products and services from one business to another.

“Working capital” refers to capital available to a business in the short term, calculated by current assets minus current liabilities. This capital can be used for things such as short-term debt, additional inventory, or expansion.

“Automated clearing house” (ACH) refers to a computer-based clearing house and settlement facility established to process the exchange of electronic transactions between participating financial institutions.

“Faster payments service” (FPS) refers to a banking initiative that allows for relatively fast bank transfers for payments less than £250,000.

A “payment instruction file” (PIF) refers to a file used to execute a bank transfer, including requisite information for the associated type of bank transfer (e.g., NACHA for ACH payments).

A “virtual card number” (VCN) refers to a credit card number not associated with a physical payment card. VCNs are typically used for online purchases and may be for single-use transactions. The VCN can include a unique card number, an expiration date, a card security code, and a set amount of payment.

Advantageously, the use of a VCN protects both the consumer and the bank. VCNs can protect the consumer against fraudulent charges by limiting the exposure of the active card details. VCNs can protect banks against chargebacks.

A “merchant” refers to a provider of goods or services in exchange for payment. The merchant can be physically present at the sale or remote, such as an online retailer. An “acquirer” refers to a party that processes payments on behalf of the merchant in a payment card transaction. The acquirer can be a bank or other institution associated with the merchant.

An “issuer” refers to a bank or other institution that provides payment cards to the cardholder. A “payment network” refers to a network that routes transaction information to the appropriate issuer. An example of a payment network is the one operated by Mastercard International Incorporated.

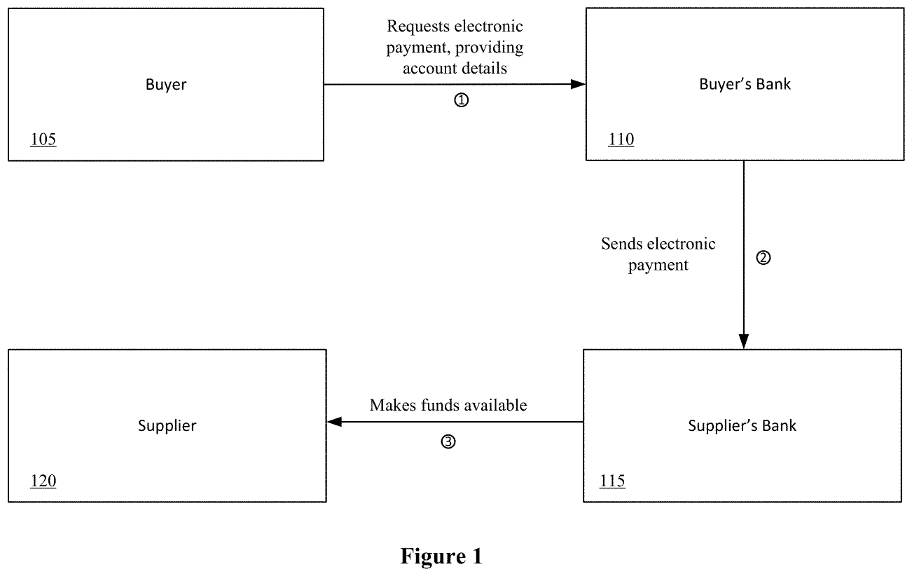

FIG. 1 illustrates an example conventional electronic payment process. Referring to FIG. 1, a buyer 105, having an account with buyer's bank 110, can make a payment to a supplier 120, having an account with a different bank (e.g., supplier's bank 115). The payment may be any suitable electronic bank-to-bank payment. For example, the electronic payment may be an ACH payment or an FPS payment.

The buyer 105 can initiate an electronic payment to the supplier 120 through a request with the buyer's bank 110, as shown in (step 1). The buyer 105 can provide account details of the supplier 120. The details of the transaction can include, but are not limited to, an amount of the payment, a destination account address, and buyer's account. The destination account address and buyer's account can be represented by, for example, sort codes or routing numbers. The request may be made, for example, using a mobile device or through online or telephone banking. This request can be in the form of a payment instruction file, for example in NACHA file format for an ACH transfer.

After the request is received by the buyer's bank 110, the buyer's bank 110 may initiate an electronic bank transfer to the supplier's bank 115, as shown in (step 2).

The electronic bank transfer may be done according to a variety of payment clearing systems, including ACH or FPS. The execution of the bank transfer differs depending on the type of payment clearing system used. For example, in ACH, an intermediary system is used to ensure the payment goes through according to terms of the request. In this scenario, money is sent from the buyer's bank 110 to the intermediary system. After the intermediary system ensures that the amount was sent, the intermediary system can send payment to the supplier's bank 115.

After acknowledging receipt of the electronic payment, and thus finalizing the ACH bank transfer, the money can be moved internally to a bank account associated with the supplier 120. Thus, the supplier's bank 115 makes the funds available to the supplier 120, as shown in (step 3).

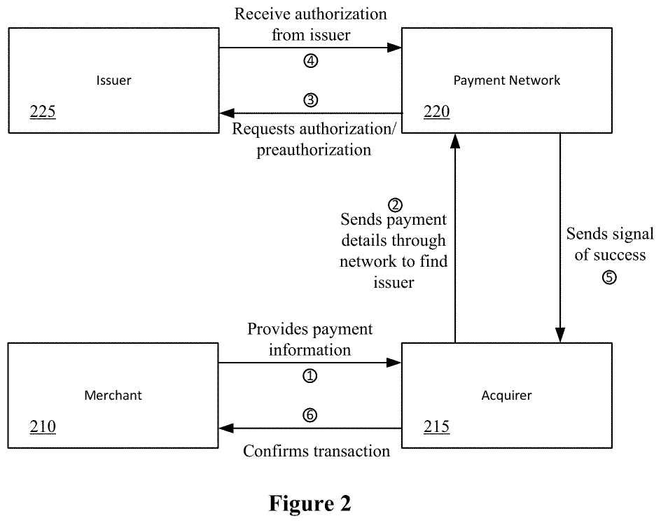

FIG. 2 illustrates an example conventional payment card process. Referring to FIG. 2, in conventional payment card processes, there can be communication between a merchant 210, an acquirer 215, a payment network 220, and an issuer 225. These communications can include payment card authorization, clearing, and settlement.

A process of payment card authorization can begin with a customer providing a form of payment to purchase goods or services. In the event that the form of payment is a credit card, either a physical card or a contactless card (e.g., hosted on a mobile device, and available on an e-wallet), a point-of-sale (POS) terminal for the merchant 210 can be used to obtain the information for payment. The POS system can extract information about the form of payment such as the credit card number, confirmation code, and expiration date, and can also record information about the purchase, such as location, amount, goods type, and a form of verification provided. This information can be provided to an acquirer 215 associated with the merchant 210 as shown in (step 1). The acquirer 215 can, in turn, provide the information to the payment network 220 associated with the form of payment as shown in (step 2).

The payment network 220 can identify an issuing bank, or issuer 225, of the customer's form of payment. The transaction can be logged to aid in later processes, such as clearing and settlement. When the payment network 220 identifies the issuer 225, the payment network 220 can send some of the payment information and request authorization and/or preauthorization on the payment method, as shown in (step 3).

The issuer 225 can respond to the requested authorization or preauthorization. Authorization can entail ensuring that a transaction is legitimate, such as by checking the provided verification, location, and amount. For example, a provided form of verification can be compared against previously given verification, including biometrics, to determine if the customer is the legitimate cardholder. Similarly, the issuer 225 can compare the location of the merchant 210 against typical spending locations for the cardholder to detect fraudulent charges. as another measure, the issuer 225 can determine that a purchase is likely to be too high to be legitimate and flag the purchase as possibly fraudulent. The authorization can also check to see if the card is currently locked or suspended. Pre-authorization can entail determining that a customer has sufficient credit to make the transaction. A credit card pre-authorization is a temporary hold on the funds that last for a period of time (e.g., five days). During the temporary hold, the cardholder cannot spend the money anywhere else, but the charge may not actually show up on their credit card statement. After one or more of these checks are performed, the issuer 225 can accept the transaction and forward a signal of success or failure back to the payment network 220 as shown in (step 4).

Once the signal is received, the payment network 220 can forward the signal to the acquirer 215 as shown in (step 5). The acquirer 215 can then forward the signal back to the merchant 210 as shown in (step 6) to confirm that the transaction has been accepted. Later on, settlement and clearing can occur. In clearing, the payment information can be double checked for accuracy. In settlement, the issuer 225 can transfer funds to the payment network 220; the payment network 220 can then transfer the funds to the acquirer 215. Once the acquirer 215 receives the funds, the funds can be made available to the merchant 210.

Unlike the conventional payment process, the described enhanced payment processing enables a credit payment to be received as a bank to bank funds transfer.

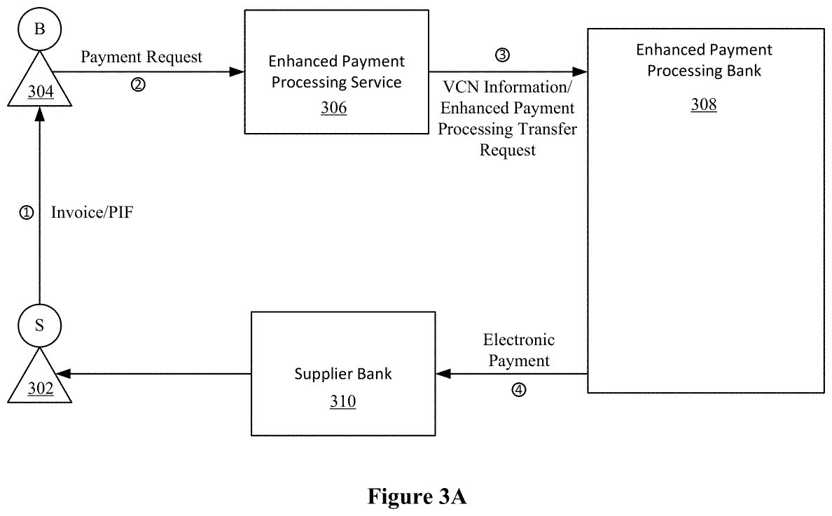

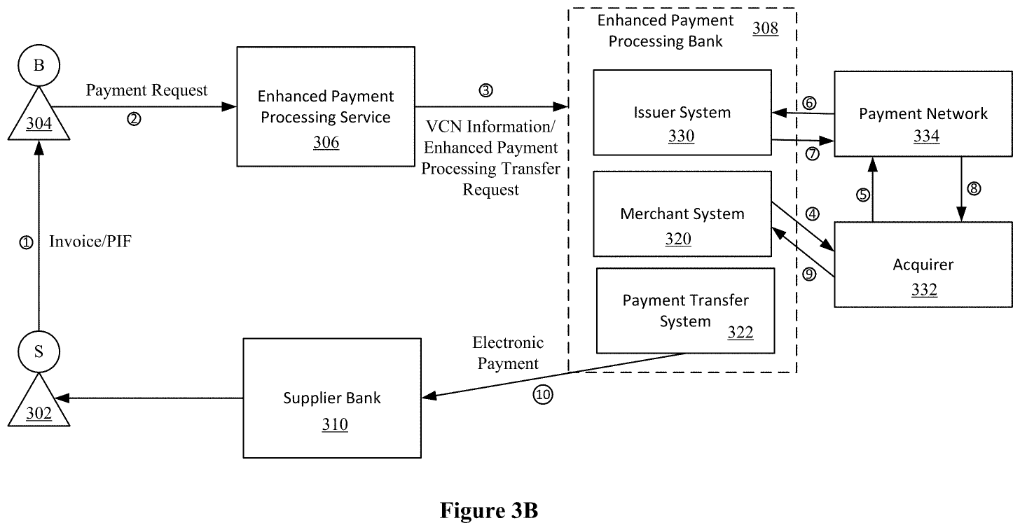

FIGS. 3A and 3B illustrate example enhanced payment processing according to example embodiments of the invention. Referring to FIG. 3A, in the illustrated example payment process using enhanced payment processing there can be communication between a supplier 302, a buyer 304, an enhanced payment processing service 306, an enhanced payment processing bank 308, and a supplier bank 310. The enhanced payment processing bank 308 is a financial institution through which the buyer 304 has an enhanced payment processing account.

The payment process using the enhanced payment processing is initiated when the supplier 302 provides an invoice to the buyer 304, as shown in (step 1). The invoice can be, for example, a PIF and include multiple transactions. The invoice includes a supplier identifier and an amount for each transaction. The supplier identifier can include information used to address the payment for the supplier (e.g., indicates payment information for the supplier). The supplier identifier can include, for example, an account number of the supplier, sort code of the supplier, or a payment address of the supplier.

In some cases, the invoice may be provided by the supplier 302 to the buyer 304 through email or as a physical paper. In some cases, the invoice may be provided by the supplier 302 through an online payment system. In this case, the invoice may be digitally uploaded or manually entered by the supplier 302. The payment system may be run by the supplier 302 or the buyer 304.

The buyer 304 can communicate a request to make a payment to the supplier 302 to the enhanced payment processing service 306, as shown in (step 2). The request can include payment information, such as one or more transactions. Each transaction can include at least the supplier identifier and the amount of the payment.

In some cases, the request may include the invoice provided by the supplier 302. The buyer 304 can communicate the request through any suitable payment interface, such as through a payment portal. For example, the buyer 304 may upload the invoice to the enhanced payment processing service 306 through a payment portal. The payment portal may be accessed through a separate enhanced payment processing application or through an existing bank application.

In some cases, step 1 and step 2 may be a single step (e.g., the invoice is transferred directly to the enhanced payment processing service 306). For example, in cases where the invoice is provided through a payment system, the payment system can directly communicate, upon request of the buyer 304, to the enhanced payment processing service 306.

The enhanced payment processing service 306 can obtain VCN information for each transaction received with the request for the enhanced payment processing transfer described in step 2. Each obtained VCN information is unique and associated with one transaction. The VCN information can include a unique virtual card number, an expiration date, a card security code, and a set amount of payment. The VCN information is linked to the enhanced payment processing account of the buyer 304.

The enhanced payment processing service 306 can obtain VCN information for each transaction in a variety of ways. In some cases, the enhanced payment processing service 306 can generate the VCN information. In some cases, the enhanced payment processing service 306 can communicate with a separate service to request the VCN information; and receive the VCN information from the separate service.

Advantageously, the use of a VCN protects both the consumer and the bank. VCNs can protect the consumer against fraudulent charges by limiting the exposure of the active card details. VCNs can protect banks against chargebacks.

The enhanced payment processing service 306 can communicate, for each transaction, the VCN information and a request for an enhanced payment processing transfer to the enhanced payment processing bank 308, as shown in step 3. The request for the enhanced payment processing transfer can be a request for an electronic payment transfer from the enhanced payment processing bank 308 to a financial institution associated with the supplier identifier (e.g., the supplier bank 310), such as an ACH payment or an FPS payment.

The request for the enhanced payment processing transfer can include the supplier identifier and the amount of the payment. In some cases, the request can include any additional information required to make an electronic payment to the supplier 302.

The VCN information and the request for the enhanced payment processing transfer may be communicated in the same or separate requests. In addition, the enhanced payment processing service 306 can, in some cases, send multiple transactions (and corresponding VCNs) in one communication to the enhanced payment processing bank 308.

The enhanced payment processing bank 308 can identify whether there is available credit for the buyer 304 using the VCN received from the enhanced payment processing service 306. Enhanced payment processing bank 308 can identify whether there is available credit for the buyer 304 using a conventional payment card process, such as that described with respect to FIG. 2, but where the enhanced payment processing bank 308 functions as both the merchant and the issuer.

Once the enhanced payment processing bank 308 identifies that there is available credit, the enhanced payment processing bank 308 can affect electronic payment to the bank account of the supplier 302 using the seller identifier and the amount of the payment received from the enhanced payment processing service 306, as shown in (step 4). That is, the enhanced payment processing bank 308 can credit the supplier bank 310 with the electronic payment funds, such as described with respect to step 2 of FIG. 1. The electronic payment can be any electronic bank to bank payment such as an ACH payment or an FPS payment.

Upon receiving the electronic payment funds described in step 4, the supplier bank 310 makes the electronic payment funds available to the supplier 302. The supplier 302 can then have immediate/near immediate access to the deposited funds.

Referring to FIG. 3B, in the illustrated example payment process using enhanced payment processing there can be communication between a supplier 302, a buyer 304, an enhanced payment processing service 306, an enhanced payment processing bank 308, and a supplier bank 310. FIG. 3B provides a more detailed description of the example payment process using enhanced payment processing described with respect to the enhanced payment processing bank 308.

In the described payment process using enhanced payment processing, the enhanced payment processing bank 308 can include functionality to act as the issuer of the enhanced payment processing payment card associated with the enhanced payment processing account of the buyer 304, the merchant, and the payment transferrer. Indeed, the enhanced payment processing bank 308 can include a merchant system 320, a payment transfer system 322, and an issuer system 330. The enhanced payment processing bank 308 can communicate with an acquirer 332 and a payment network 334.

Similar to the payment process using enhanced payment processing described with respect to FIG. 3A, the process is initiated when the supplier 302 provides an invoice to the buyer 304, as shown in (step 1). The invoice can be, for example, a PIF and include multiple transactions. The invoice includes a supplier identifier and an amount for each transaction. The supplier identifier can include information used to address the payment for the supplier (e.g., indicates payment information for the supplier). The supplier identifier can include, for example, an account number of the supplier, sort code of the supplier, or a payment address of the supplier.

In some cases, the invoice may be provided by the supplier 302 through email or as a physical paper. In some cases, the invoice may be provided by the supplier 302 through an online payment system. In this case, the invoice may be digitally uploaded or manually entered by the supplier 302. The payment system may be run by the supplier 302 or the buyer 304.

The buyer 304 can communicate a request to make a payment to the supplier 302 to the enhanced payment processing service 306, as shown in (step 2). The request can include payment information, such as one or more transactions. Each transaction can include at least the supplier identifier and the amount of the payment.

In some cases, the request may include the invoice provided by the supplier 302. The buyer 304 can communicate the request through any suitable payment interface, such as through a payment portal. For example, the buyer 304 may upload the invoice to the enhanced payment processing service 306 through a payment portal. The payment portal may be accessed through a separate enhanced payment processing application or through an existing bank application.

In some cases, step 1 and step 2 may be a single step (e.g., the invoice is transferred directly to the enhanced payment processing service 306). For example, in cases where the invoice is provided through a payment system, the payment system can directly communicate, upon request of the buyer 304, to the enhanced payment processing service 306.

The enhanced payment processing service 306 can obtain VCN information for each transaction received with the request for the enhanced payment processing transfer described in step 2. Each obtained VCN information is unique and associated with one transaction. The VCN information can include a unique virtual card number, an expiration date, a card security code, and a set amount of payment. The VCN information is linked to the enhanced payment processing account of the buyer 304.

The enhanced payment processing service 306 can obtain VCN information for each transaction in a variety of ways. In some cases, the enhanced payment processing service 306 can generate the VCN information. In some cases, the enhanced payment processing service 306 can communicate with a separate service to request the VCN information; and receive the VCN information from the separate service.

Advantageously, the use of a VCN protects both the consumer and the bank. VCNs can protect the consumer against fraudulent charges by limiting the exposure of the active card details. VCNs can protect banks against chargebacks.

The enhanced payment processing service 306 can communicate, for each transaction, the VCN information and a request for an enhanced payment processing transfer to the enhanced payment processing bank 308, as shown in step 3. The request for the enhanced payment processing transfer can be a request for an electronic payment transfer from the enhanced payment processing bank 308 to a financial institution associated with the supplier identifier (e.g., the supplier bank 310), such as an ACH payment or an FPS payment.

The request for the enhanced payment processing transfer can include the supplier identifier and the amount of the payment. In some cases, the request can include any additional information required to make an electronic payment to the supplier 302.

The VCN information and the request for the enhanced payment processing transfer may be communicated in the same or separate requests. In addition, the enhanced payment processing service 306 can, in some cases, send multiple transactions (and corresponding VCNs) in one communication to the enhanced payment processing bank 308.

The enhanced payment processing bank 308 can identify whether there is available credit for the buyer 304 using the VCN received from the enhanced payment processing service 306. Enhanced payment processing bank 308 can identify whether there is available credit for the buyer 304 using a conventional payment card process, such as that described with respect to FIG. 2, but where the enhanced payment processing bank 308 functions as both the merchant and the issuer.

In the described payment process using enhanced payment processing, the merchant system 320 can obtain the VCN information communicated to the enhanced payment processing bank 308. The merchant system 320 can communicate with the acquirer 330, the payment network 334, and the issuer system 330 to perform a payment card process, such as described with respect to FIG. 2.

For example, the VCN information can be provided to the acquirer 332, as shown in (step 4). The acquirer 332 can, in turn, provide the VCN information to the payment network 334 associated with the form of payment, as shown in (step 5).

The payment network 334 can identify an issuing bank, or issuer, of the customer's form of payment. In this case, the issuer is the enhanced payment processing bank 308, which processes the payment at the issuer system 330 of the enhanced payment processing bank 308.

The transaction can be logged to aid in later processes, such as clearing and settlement. When the payment network 334 identifies the issuer system 330, the payment network 334 can send the VCN information and request authorization and/or preauthorization on the payment method, as shown in (step 6).

The issuer system 330 can run the requested authorization or preauthorization. After one or more of the checks described with respect to FIG. 2 are performed, the issuer system 330 can accept the transaction and forward a signal of success or failure back to the payment network 334, as shown in (step 7).

Once the signal is received, the payment network 334 can forward the signal to the acquirer 332 as shown in (step 8). The acquirer 332 can then forward the signal back to the merchant system 320, as shown in (step 9) to confirm that the transaction has been accepted. In some cases, the acquirer 332 is part of the merchant system 320.

It should be understood that settlement and clearing can occur at a later time.

Once the enhanced payment processing bank 308 identifies that there is available credit, the enhanced payment processing bank 308 can affect electronic payment to the bank account of the supplier 302 using the supplier identifier and the amount of the payment received from the enhanced payment processing service 306, as shown in (step 10).

In the described payment process using the enhanced payment processing process, the payment transfer system 322 can obtain the enhanced payment processing transfer request communicated to the enhanced payment processing bank 308. The payment transfer system 322 can obtain the supplier identifier and the amount of the payment. Step 10 may be performed using any suitable electronic payment process, such as step 2 in the conventional electronic payment process described with respect to FIG. 1.

The merchant system 320 can communicate the processing result of the VCN information to the payment transfer system 322. If the merchant system 320 indicates that there is available credit, the payment transfer system 322 can affect electronic payment to the bank account of the supplier 302 using the supplier identifier and the amount of payment.

That is, the payment transfer system of the enhanced payment processing bank 308 can credit the supplier bank 310 with the electronic payment funds. As previously described, the electronic payment can be any electronic bank to bank payment such as an ACH payment or an FPS payment.

Upon receiving the electronic payment funds described in step 10, the supplier bank 310 can credit the account of the supplier 302 with the amount of the payment. The supplier 302 can then have immediate/near immediate access to the deposited funds.

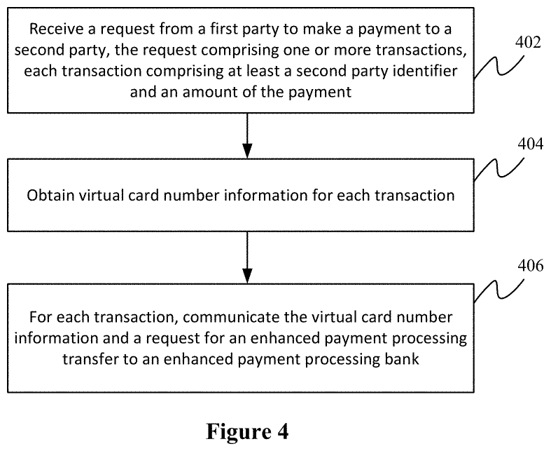

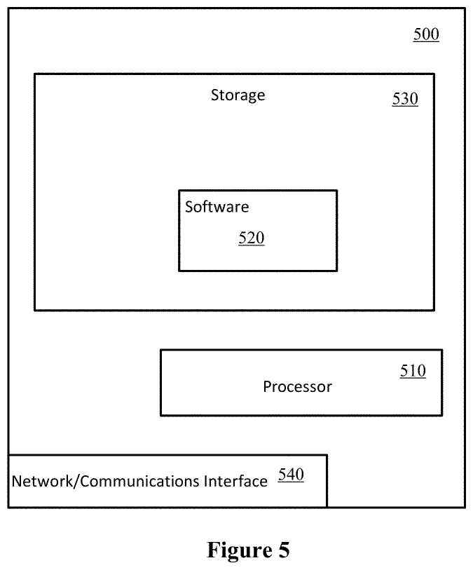

FIG. 4 shows an example process flow diagram for providing enhanced payment processing according to an embodiment of the invention. Referring to FIG. 4, an enhanced payment processing service performing process 400 can be implemented by a server embodied as described with respect to computing system 500 shown in FIG. 5.

In some cases, the enhanced payment processing service may be part of an enhanced payment processing bank. In some cases, the enhanced payment processing service may be a separate system in communication with an enhanced payment processing bank.

The communications between these systems may be, for example, via application programming interfaces (APIs). An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component. The API is generally a set of programming instructions and standards for enabling two or more applications to communicate with each other and is commonly implemented over the Internet as a set of Hypertext Transfer Protocol (HTTP) request messages and a specified format or structure for response messages according to a REST (Representational state transfer) or SOAP (Simple Object Access Protocol) architecture.

Referring to process 400, the enhanced payment processing service can receive a request from a first party to make a payment to a second party (402). The first party may be a buyer and the second party may be a supplier. The request may include one or more transactions; and each transaction can include at least a second party identifier and an amount of the payment. In some cases, the request may be received from an online payment system and can include a PIF indicating the one or more transactions.

In response to receiving the request (402), the enhanced payment processing service can obtain virtual card number information for each transaction (404). The virtual card information can include, but is not limited to, a virtual card number and expiration date, a card security code, and an amount of the payment.

The enhanced payment processing service can obtain the virtual card number information in a variety of ways. In some cases, the enhanced payment processing service can generate the virtual card number information for one or more of the transactions. In some cases, the enhanced payment processing service can communicate with a separate service to request the virtual card number information and can receive the virtual card number information from the separate service.

For each transaction, the enhanced payment processing service can communicate the virtual card number information and a request for an enhanced payment processing transfer to an enhanced payment processing bank (406). The request for the enhanced payment processing transfer can include the second party identifier and the amount of the payment.

The request for the enhanced payment processing transfer can be a request for an electronic payment transfer from the enhanced payment processing bank to a financial institution associated with the second party identifier according to a processing result of the virtual card number information. For example, if the processing result of the virtual card number information indicates there is available credit associated with the virtual card number, an electronic payment transfer to the financial institution associated with the second party identifier can be affected.

In some cases, the enhanced payment processing service may communicate the virtual card number information to a merchant system within the enhanced payment processing bank. The merchant system may process the virtual card information according to any suitable card payment process.

In some cases, the enhanced payment processing service may communicate to the request for the enhanced payment processing transfer to a payment transfer system within the enhanced payment processing bank. The payment transfer system may affect electronic payment to a bank account of the second party using the second party identifier and the amount of the payment.

Exception Process Scenarios

There are a number of places where an error may occur that can cause a transaction to not result in a bank transfer. The issue may occur as part of the credit card transaction (e.g., “authorized not cleared” error, “cleared not settled” error, “issue authorization decline” error, “authorization response” error), part of the bank transfer (e.g., ACH failure), or issues with the system itself (e.g., “system-bank transfer” error, failure to obtain VCN).

Authorized not Cleared Error

In some cases, upload and acceptance of a payment file may not result in a bank transfer. One such case is when the transaction is an “authorized not cleared” error. As previously discussed in FIG. 2, there are three stages in a standard credit card transaction: Authorization, Clearing, and Settlement. Sometimes, a transaction may encounter an issue or error. If the card successfully completes authorization, there may be a delay in clearing, perhaps due to insufficient funds on the part of the issuer, that prevents the credit card transaction from completing and, thus, the bank transfer will not occur. In the case of an “authorized not cleared” error, the user may be notified of the delay.

Cleared not Settled Error

Another such case of a payment file not resulting in a bank transfer is a “cleared not settled” error. Similar to an “authorized not cleared” error, a “cleared not settled” error can occur in between stages during a credit card transaction. Specifically, a “cleared not settled” error is when a transaction is both authorized and then later cleared, but settlement has not occurred for some reason. While clearing should always result in a settlement, the acquirer may not want to move funds until the transaction has been received in order to minimize financial risk. In the case of a “cleared not settled” error, the user may be notified of the delay.

Issuer Authorization Decline Error

In some cases, the credit card transaction may fail without an error on the part of the entities in the credit card payment process. For instance, a user may not have enough credit in an account to make a purchase. As an example, a user may try to make 10 transactions for $100 with only $500 in available credit. In this instance, the first five transactions may be approved, but the last five may be declined by the issuer for lack of available credit, since the first five transactions would put the user at their credit limit. In the case of an “issuer authorization decline” error, the user may be prompted to resubmit a request and payment, either at the time of the notification or at a later date.

Authorization Response Error

In some cases, there may be an issue preventing authorization of a transaction, resulting in an “authorization response” error. For example, an “authorization response” error may occur if no response is received from an issuer in the process of authorization or pre-authorization. In the event of an “authorization response” error, the transaction can be automatically cancelled. If the transaction is automatically cancelled, the user may be prompted to resubmit the request. In another implementation, the payment network may have discretion based on their history with a client to enable the transaction to move forward without explicit instruction from the issuer in the case of no communication.

ACH Failure Error

An “ACH failure” error may occur if the credit card transaction has successfully been completed, but there is an issue with the bank transfer. For instance, a banking platform may be temporarily down, or the destination account may not accept bank transfers of the requested variety. In the case of an “ACH failure” error, the user may be notified of the delay.

Failure to Obtain VCN Error

In some cases, the system may experience technical error at one or more points in the enhanced payment processing process that may result in a failed transaction. One example of such an error is a “failure to obtain a VCN” error. For example, if the source of the generated VCNs is nonfunctional, a VCN may not be created and the process may not be able to continue. Alternatively, a user may not have an account with a bank that serves as an issuer for the VCNs or may have a hold on their account that would prevent a VCN from being generated. In the case of a “failure to obtain VCN” error, the system may try again automatically one or more times, or the user may be prompted to resubmit.

System-Bank Transfer Error

Another error of the system that may result in a failed transaction is an issue in pushing the VCNs to the bank acting as a merchant. An example of a method of pushing the VCNs to the merchant may be MasterCard payment gateway services straight through processing. In the case of a failure to push the VCN to the merchant, one or more retries may be automatically attempted. If the error persists, the user may be prompted to resubmit.

FIG. 5 illustrates components of a computing system that may be used in certain embodiments described herein. Referring to FIG. 5, system 500 may be implemented within a single computing device or distributed across multiple computing devices or sub-systems that cooperate in executing program instructions. The system 500 can include one or more blade server devices, standalone server devices, personal computers, routers, hubs, switches, bridges, firewall devices, intrusion detection devices, mainframe computers, network-attached storage devices, and other types of computing devices. The system hardware can be configured according to any suitable computer architectures such as a Symmetric Multi-Processing (SMP) architecture or a Non-Uniform Memory Access (NUMA) architecture.

The system 500 can include a processing system 510, which may include one or more processors and/or other circuitry that retrieves and executes software 520 from storage system 530. Processing system 510 may be implemented within a single processing device but may also be distributed across multiple processing devices or sub-systems that cooperate in executing program instructions.

Storage system(s) 530 can include any computer readable storage media readable by processing system 510 and capable of storing software 520. Storage system 530 may be implemented as a single storage device but may also be implemented across multiple storage devices or sub-systems co-located or distributed relative to each other. Storage system 530 may include additional elements, such as a controller, capable of communicating with processing system 510. Storage system 530 may also include storage devices and/or sub-systems on which data is stored. System 500 may access one or more storage resources in order to access information to carry out any of the processes indicated by software 520.

Software 520, including routines for performing processes such as processes 400 for the enhanced payment processing service may be implemented in program instructions and among other functions may, when executed by system 500 in general or processing system 510 in particular, direct the system 500 or processing system 510 to operate as described herein.

In embodiments where the system 500 includes multiple computing devices, the server can include one or more communications networks that facilitate communication among the computing devices. For example, the one or more communications networks can include a local or wide area network that facilitates communication among the computing devices. One or more direct communication links can be included between the computing devices. In addition, in some cases, the computing devices can be installed at geographically distributed locations. In other cases, the multiple computing devices can be installed at a single geographic location, such as a server farm or an office.

A communication interface 540 may be included, providing communication connections and devices that allow for communication between system 500 and other computing systems (not shown) over a communication network or collection of networks (not shown) or the air.

In some embodiments, system 500 may host one or more virtual machines.

Alternatively, or in addition, the functionality, methods and processes described herein can be implemented, at least in part, by one or more hardware modules (or logic components). For example, the hardware modules can include, but are not limited to, application-specific integrated circuit (ASIC) chips, field programmable gate arrays (FPGAs), system-on-a-chip (SoC) systems, complex programmable logic devices (CPLDs) and other programmable logic devices now known or later developed. When the hardware modules are activated, the hardware modules perform the functionality, methods and processes included within the hardware modules.

It should be understood that as used herein, in no case do the terms “storage media,” “computer-readable storage media” or “computer-readable storage medium” consist of transitory carrier waves or propagating signals. Instead, “storage” media refers to non-transitory media.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A computing device comprising:
a processor;
a storage device; and
instructions stored in the storage device that when executed by the processor, direct the computing device to:
receive a request from a first party to make a payment to a second party, the request comprising one or more transactions, each transaction comprising at least a second party identifier and an amount of the payment;
in response to receiving the request, obtain virtual card number information for each transaction; and
for each transaction, communicate the virtual card number information and a request for an enhanced payment processing transfer to an enhanced payment processing bank, the request for the enhanced payment processing transfer being a request for an electronic payment transfer from the enhanced payment processing bank to a financial institution associated with the second party identifier according to a processing result of the virtual card number information, the request for the enhanced payment processing transfer comprising the second party identifier and the amount of the payment.

2. The computing device of claim 1, wherein the instructions to obtain the virtual card number information direct the computing device to:
send a request to an external service for the virtual card number information; and
receive the virtual card number information.

3. The computing device of claim 1, wherein the instructions to obtain the virtual card number information direct the computing device to generate the virtual card number information.

4. The computing device of claim 1, wherein the request for the enhanced payment processing transfer is a request for an automated clearing house transfer.

5. The computing device of claim 1, wherein the request for the enhanced payment processing transfer is a request for a faster payment systems transfer.

6. The computing device of claim 1, wherein the virtual card number information comprises a virtual card number, an expiration date, a card security code, and the amount of the payment.

7. The computing device of claim 1, wherein the first party is a buyer and the second party is a supplier.

8. The computing device of claim 1, further comprising:
in response to communicating the virtual card number information and the request for the enhanced payment processing transfer, receiving an indication of one or more failed authorizations for the one or more transactions.

9. One or more computer-readable storage media having instructions for an enhanced payment processing service stored thereon that when executed, direct a processing system to:
receive a request from a first party to make a payment to a second party, the request comprising one or more transactions, each transaction comprising at least a second party identifier and an amount of the payment;
in response to receiving the request, obtain virtual card number information for each transaction; and
for each transaction, communicate the virtual card number information and a request for an enhanced payment processing transfer to an enhanced payment processing bank, the request for the enhanced payment processing transfer being a request for an electronic payment transfer from the enhanced payment processing bank to a financial institution associated with the second party identifier according to a processing result of the virtual card number information, the request for the enhanced payment processing transfer comprising the second party identifier and the amount of the payment.

10. The media of claim 9, wherein the instructions to obtain the virtual card number information direct the processing system:
send a request to an external service for the virtual card number information; and
receive the virtual card number information.

11. The media of claim 9, wherein the instructions to obtain the virtual card number information direct the processing system to generate the virtual card number information.

12. The media of claim 9, wherein the request for the enhanced payment processing transfer is a request for an automated clearing house transfer.

13. The media of claim 9, wherein the request for the enhanced payment processing transfer is a request for a faster payment systems transfer.

14. The media of claim 9, wherein the virtual card number information comprises a virtual card number, an expiration date, a card security code, and the amount of the payment.

15. A method comprising:
receiving a request from a first party to make a payment to a second party, the request comprising one or more transactions, each transaction comprising at least a second party identifier and an amount of the payment;
in response to receiving the request, obtaining virtual card number information for each transaction; and
for each transaction, communicating the virtual card number information and a request for an enhanced payment processing transfer to an enhanced payment processing bank, the request for the enhanced payment processing transfer being a request for an electronic payment transfer from the enhanced payment processing bank to a financial institution associated with the second party identifier according to a processing result of the virtual card number information, the request for the enhanced payment processing transfer comprising the second party identifier and the amount of the payment.

16. The method of claim 15, wherein the obtaining of the virtual card number information comprises:
sending a request to an external service for the virtual card number information; and
receiving the virtual card number information.

17. The method of claim 15, wherein the obtaining of the virtual card number information comprises generating the virtual card number information.

18. The method of claim 15, wherein the request for the enhanced payment processing transfer is a request for an automated clearing house transfer.

19. The method of claim 15, wherein the request for the enhanced payment processing transfer includes a request for a faster payment systems transfer.

20. The method of claim 15, wherein the virtual card number information comprises a virtual card number, an expiration date, a card security code, and the amount of the payment.
